(19) United States
(12) Patent Application Publication
(10) Pub. No.: US 2024/0053167 A1
(43) Pub. Date: Feb. 15, 2024

(54) SYSTEM AND METHOD FOR ROAD FEATURE DETECTION

(71) Applicant: ClearMotion, Inc., Billerica, MA (US)

(72) Inventor: Nikolaos Karavas, Cambridge, MA (US)

(73) Assignee: ClearMotion, Inc., Billerica, MA (US)

(21) Appl. No.: 18/267,912

(22) PCT Filed: Dec. 21, 2021
(86) PCT No.: PCT/US2021/064743

§ 371 Date: Jun. 16, 2023

Related U.S. Application Data
(60) Provisional application No. 63/129,245, filed on Dec. 22, 2020.

(51) Int. Cl. G01C 21/00; G06N 3/088

(52) U.S. Cl. CPC G01C 21/3822; G01C 21/3837; G06N 3/088

(57) ABSTRACT

Methods and systems for generating a map of road features are provided. A method may include obtaining a vehicle motion profile, inputting the vehicle motion profile to a trained statistical model, and outputting one or more road features from the trained statistical model. A method may include obtaining first vehicle motion profiles, obtaining second vehicle motion profiles, generating a trained statistical model using the first vehicle motion vehicle motion profiles and the second vehicle motion profiles, and storing the trained statistical model in non-volatile computer readable memory.

### RELATED APPLICATIONS

This application claims the benefit of priority under 35 U.S.C. § 119(e) of U.S. Provisional Application Ser. No. 63/129,245, filed Dec. 22, 2020, the disclosure of which is incorporated herein by reference in its entirety.

### FIELD

Disclosed embodiments are related to systems for road feature detection, detection of characteristics of a road feature, and related methods of use.

### BACKGROUND

Roads designed for vehicle travel may contain a number of discrete features such as, for example, potholes, speed bumps, manhole covers, etc. When a vehicle traverses such a feature, adverse results may arise. For example, undesirable vertical motion may be transmitted to the vehicle body, thereby resulting in a degraded experience for an occupant of the vehicle. Additionally, traversing such features may cause damage to components of the vehicle (e.g., by blowing out a tire, bending or deforming a rim, generally increasing wear and tear on suspension components, etc.).

### SUMMARY

In some embodiments, a method includes obtaining a vehicle motion profile applied to a portion of one or more vehicles traversing a road segment, inputting, to a trained statistical model, the vehicle motion profile, where the trained statistical model is configured to identify one or more road features associated with the road segment based at least in part on the vehicle motion profile, and outputting, from the trained statistical model, the one or more road features.

In some embodiments, a method includes obtaining first vehicle motion profiles applied to a portion of one or more vehicles traversing a first road segment associated with one or more road features, obtaining second vehicle motion profiles applied to a portion of one or more vehicles traversing a second road segment associated with an absence of the one or more road features, generating a trained statistical model using the first vehicle motion profiles and the second vehicle motion profiles, and storing, in non-volatile computer readable memory, the trained statistical model.

In some embodiments, at least one non-transitory computer-readable storage medium stores programming instructions that, when executed by at least one processor, causes the at least one processor to perform a method including obtaining a vehicle motion profile applied to a portion of one or more vehicles traversing a road segment, inputting, to a trained statistical model, the vehicle motion profile, where the trained statistical model is configured to identify one or more road features associated with the road segment based at least in part on the vehicle motion profile, and outputting, from the trained statistical model, the one or more road features.

In some embodiments, at least one non-transitory computer-readable storage medium stores programming instructions that, when executed by at least one processor, causes the at least one processor to perform a method including obtaining first vehicle motion profiles applied to a portion of one or more vehicles traversing a first road segment associated with one or more road features, obtaining second vehicle motion profiles applied to a portion of one or more vehicles traversing a second road segment associated with an absence of the one or more road features, generating a trained statistical model using the first vehicle motion profiles and the second vehicle motion profiles, and storing, in non-volatile computer readable memory, the trained statistical model.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts a schematic of an embodiment of a vehicle;

FIG. 2A depicts an exemplary chart showing a first embodiment of vertical wheel acceleration of a vehicle;

FIG. 2B depicts an exemplary chart showing a second embodiment of vertical wheel acceleration of a vehicle;

FIG. 3 is a flow chart for one embodiment of a method of controlling a vehicle;

FIG. 4 is a flow chart for one embodiment of a method of determining the presence of a road feature using a vehicle motion profile;

FIG. 5 is a flow chart for one embodiment of a method related to training a statistical model associated with vehicle motion profiles;

FIG. 6 is a flow chart for another embodiment of a method related to training a statistical model associated with vehicle motion profiles;

FIG. 7 is a flow chart for one embodiment of a method of determining a road feature characteristic using a vehicle motion profile;

FIG. 8 is a schematic of one embodiment of a trained statistical model; and

FIG. 9 is a schematic embodiment of a system for training and/or implementing the models disclosed herein.

### DETAILED DESCRIPTION

The inventors have appreciated that roadways are constantly changing and have a wide variation of hazards and other features that impact the vehicles traversing said roadways. The locations and characteristics of hazards change over time as roadways are managed by local, regional, state, or national government agencies. Accordingly, tracking and characterizing road features is difficult to achieve manually, or even with an automated processes because the scale of a road network and the ever-changing nature of road features, which change the data inputs to an automated system. Moreover, road features may be characterized in many different ways, and a type of road feature is just one of many characteristics that may affect a vehicle encountering the road feature.

The inventors have also appreciated that there is a large amount of rich data available that relates to the observed motion of one or more portions of a vehicle as it traverses a roadway. For example, data may include wheel rotation, wheel vertical motion (e.g., acceleration, velocity, displacement), vehicle vertical motion (e.g., acceleration, velocity, displacement), vehicle longitudinal motion (e.g., acceleration, velocity, displacement), or other data. However, the inventors have also appreciated that traditional analysis techniques are not able to reliably identify road features and/or road feature characteristics, and/or reliable techniques are computationally expensive and impractical to implement for an entire roadway network.

In some instances, a map of road features may be generated using the above noted approaches. For example, in some cases, specific thresholds or patterns may be selected by a human as corresponding to a particular road feature. Road features may then be computational identified by determining if the data matches the specified criteria. However, such manually determined criteria are subject to bias and human error and this process may not reliably capture all road features consistently. As another example, a human may survey each road in an area and manually note the location of road features as well as the type and, optionally, other road feature characteristics (e.g., size) of each road feature. Such a map may be manually updated as road conditions change (e.g., as road features are repaired, or as new road features emerge). Such an approach requires substantial labor and may likely prove impractical for large areas with many roads. As yet another example, a crowd-sourced method that depends on reporting by a vehicle occupant may be employed. In this approach, when a vehicle occupant (e.g., a driver or passenger) observes a road feature, they may report its location and optionally other information about the road feature (e.g., road feature characteristics), and the reported location and/or information may be saved in a database. A mobile app may be utilized for such reporting, and user reporting of road features may be encouraged by some type of gamification or reward system. However, such an approach relies on third parties and self-reporting and may accordingly be vulnerable to inconsistency or unreliability.

As the above approaches for generating a map of road features depend substantially on human input, they may be vulnerable to inconsistency or unreliability. The inventors have therefore recognized the advantages in developing an automated approach for recognizing road features that are present in a road surface. In particular, the inventors have appreciated the benefits of a trained statistical model (e.g., a machine learning model) that may be implemented to identify road features and/or road feature characteristics. Such a trained statistical model may be employed to generate a map of road features, which may be employed by a vehicle in proactive vehicle control in some embodiments, as discussed further below.

In one exemplary method, a vehicle motion profile (e.g., a vertical motion profile) that is indicative of the motion experienced by at least a portion of a vehicle in response to traversal of a road segment may first be obtained. A motion profile may contain information about vehicle motion (e.g., acceleration, velocity, and/or displacement) in at least one of three dimensions (e.g., vertical, lateral, longitudinal). After optional preprocessing, for example, as described herein, the motion profile may then be input to a trained statistical model configured to identify the presence or absence of a road feature along the road segment. In some embodiments, the trained statistical model or a second trained statistical model may determine the presence of one or more road feature characteristics indicative of interaction with a particular type of road feature. As a simplified example, a speed bump may be associated with a sharp upward movement of a wheel of the vehicle as it first encounters the bump, followed by a downward movement of the wheel at the end of the bump. Thus, inputting a motion profile (e.g., vertical motion profile) including sharp upward movement followed by a sharp downward movement into a trained statistical model may result in the trained statistical model identifying a road feature type of a bump in the road segment traversed by the vehicle. In some embodiments, the identified road features and/or road feature characteristics may be associated with geographical locations. In some embodiments, a method may include generating a map based on the geographical locations of the road features.

A trained statistical model according to exemplary embodiments described herein may be a machine learning model such as a support vector machine (SVM), neural network, a decision tree, and/or any other appropriate model. The trained statistical model may be configured to receive inputs which include vehicle motion data (e.g., vehicle motion profiles). The trained statistical model may be configured to output identified road features and/or identified road feature characteristics. In some embodiments, the trained statistical model maybe employed in an automated method, whereby vehicle motion profiles are input to the trained statistical model and one or more road features are identified using the vehicle motion profiles. In some embodiments, the trained statistical model may be combined with a localization system (e.g., global navigational satellite system, terrain-based localization system, lane-identification system, dead reckoning system, etc.) configured to localize a vehicle. In such embodiments, a location of each road feature (either in absolute coordinates or as a location relative to a reference point) may be determined using the location of the vehicle when each road feature is encountered. The road feature and the corresponding location may be then recorded to generate a map of road features. Such a map may be utilized for proactive vehicle control as discussed further below.

In some embodiments, a method may include obtaining first vehicle motion profiles applied to a portion of a vehicle traversing a first road segment associated with one or more road features. The method may also include obtaining second vehicle motion profiles applied to a portion of a vehicle traversing a second road segment associated with an absence of the one or more road features. In some embodiments, the first vehicle motion profiles may be identified as being associated with the presence of a road feature via user input. Likewise, in some embodiments, the second vehicle motion profiles may be identified as being associated with the absence of the one or more road features via user input.

In some embodiments, the first vehicle motion profiles and second vehicle motion profiles may be optionally filtered or otherwise transformed to normalize data and provide more consistent detectable features. For example, in some embodiments, the first vehicle motion profiles and the second vehicle motion profiles may be transformed into a frequency domain (e.g., using a Fourier transform). In some other embodiments, the first vehicle motion profiles and the second vehicle motion profiles may be transformed from a time domain into a distance domain (e.g., using known vehicle velocity). In some embodiments, the first vehicle motion profiles and the second vehicle motion profiles may be filtered to attenuate one or more vehicle-specific characteristics (e.g., wheel-hop frequencies). The filter may be a notch filter, low-pass filter, high pass filter, bandpass filter, or any other suitable filter, as the present disclosure is not so limited.

In some embodiments, a method may include generating a trained statistical model using a plurality of motion profiles, e.g., the above noted first vehicle motion profiles and second vehicle motion profiles (e.g., the first and second vehicle motion profiles are employed as training data). The trained statistical model may be configured to identify the presence of one or more types of road features within subsequently input vehicle motion data. The generated trained statistical model may be stored for subsequent use (e.g., in non-volatile computer readable memory).

In some embodiments, a method may include obtaining first vehicle motion profiles applied to a portion of a vehicle traversing a first road segment associated with a first road feature characteristic. The method may also include obtaining second vehicle motion profiles applied to a portion of a vehicle traversing a second road segment associated with a second road feature characteristic. In some embodiments, the associations of the first and second road feature characteristics may be identified via user input. In some embodiments, a road feature characteristic may be a road feature type. For example, the first road feature characteristic may be a pothole, and the second road feature characteristic may be a bump. In some embodiments, a road feature characteristic may be a vehicle response duration or a response frequency. In some embodiments, a road feature characteristic may be a magnitude of vehicle motion. In some embodiments, a road feature characteristic may be a vehicle response to a road feature. For example, a first road feature characteristic may include extension of a suspension system, and a second road feature characteristic may include compression of a suspension system. Of course, any suitable road feature characteristic may be employed alone or in combination, as the present disclosure is not so limited. In some embodiments, the first vehicle motion profiles and second vehicle motion profiles may be optionally filtered or otherwise transformed to normalize data and provide more consistent detectable road feature characteristics. The method may include generating a trained statistical model using the first vehicle motion profiles and the second vehicle motion profiles (e.g., the first and second vehicle motion profiles are employed as training data) though any number of vehicle motion profiles associated with any number of road feature characteristics may be used. The trained statistical model may be configured to identify the first road feature characteristic and the second road feature characteristic within a subsequently input vehicle motion data. The generated trained statistical model may be stored for subsequent use (e.g., in non-volatile computer readable memory).

The inventors have also appreciated that in some cases, providing user identified training data to generate a trained statistical model may be time consuming and susceptible to human bias that may cause a trained statistical model to lack consistency. In some cases, a trained statistical model may be trained on user identified road feature types, which may not encompass all uniquely identifiable types of road features. For example, a user verified training data set may include bumps and potholes, but not a combined bump and pothole that may impart unique motion on a vehicle encountering the combined bump and pothole. A trained statistical model only trained to identify bumps and potholes may not be able to identify the combined bump and pothole, may incorrectly identify the road feature as a pothole or bump, or may identify two road features where there is only one road feature. As another example, there are several road anomalies found in public roads due to asphalt deterioration (e.g., large cracks) that may not be readily categorizable as a road feature type. Accordingly, the inventors have appreciated the benefits of employing training data, which is not user verified, but rather employs a clustering algorithm to identify different categories of road features to train a statistical model. In this manner, the identification of road features and/or road feature characteristics used to train a statistical model may be unsupervised (e.g., performed without user verification). By using a such a method, groups of different road features may be identified based on their apparent effect in the vehicle (e.g., based on a vehicle motion profile). In some instances, the grouped road features may be identified by a user to identify the type of road feature the various groups correspond to.

In some embodiments, a method of generating a trained statistical model may include obtaining a plurality of vehicle motion profiles. In some embodiments, the method may also include clustering one or more portions of the vehicle motion profiles into a plurality of separate groups of similar data points (e.g., vehicle motion profiles, vehicle motion profile segments, etc.) using any desired type of clustering algorithm. As discussed above, there may be no prior knowledge regarding which cluster a data point belongs to. In some embodiments, a clustering algorithm may be applied to the plurality of vehicle motion profiles to cluster the vehicle motion profiles into previously obtained clusters, thereby associated each of the vehicle motion profiles with a cluster. However, instances in which new clusters are identified and/or an initial set of clusters are identified are also contemplated. Accordingly, in the various embodiments described herein, a clustering algorithm may be any suitable clustering algorithm, including, but not limited to, K-means, gaussian mixture models (GMM), density-based spatial (DBSCAN), and hierarchical clustering. In some embodiments, the plurality of vehicle motion profiles and the associated clusters may be used to generate a trained statistical model as elaborated on below. In some embodiments, the plurality of vehicle motion profiles may be split into a training dataset and a test dataset, where the training dataset is used to generate the trained statistical model and the test dataset is used to evaluate performance of the generated trained statistical model. In some embodiments, statistical metrics may be employed evaluate the clustering and the performance of the trained statistical model.

According to exemplary embodiments described herein, vehicle motion data, such as vehicle motion profiles, may be employed as inputs to a trained statistical model. Additionally, in some embodiments, vehicle motion data may be employed to generate a trained statistical model. As used herein, a profile may include a sequence of data over time and/or distance. Vehicle motion data may include any measurable parameters associated with the motion of a portion of a vehicle. Vehicle motion may include acceleration, velocity, and/or displacement in a longitudinal, lateral, or vertical direction. As used herein, a longitudinal direction may be a direction parallel with a travel direction of a vehicle approximately parallel to a roadway surface (e.g., forward or backward). As used herein, a lateral direction may be a direction perpendicular to a travel direction of a vehicle that is approximately parallel to a roadway surface (e.g., right or left). As used herein, a vertical direction may be a direction aligned with a direction of gravity, that in some cases may be approximately perpendicular to a roadway surface (e.g., up and down). In some embodiments, a portion of a vehicle corresponding to vehicle motion data may include a wheel, chassis, seat, or other appropriate vehicle portion. In some embodiments, vehicle motion data may include motion of multiple portions of a vehicle. In some embodiments, vehicle motion data may be measured by one or more sensors disposed on one or more portions of a vehicle. The one or more sensors may include, but are not limited to, accelerometers, force sensors, gyroscopes, inertial measurement units (IMUs), wheel spin sensors, wheel position sensors, or any other suitable sensors providing information about the motion of a portion of a vehicle. In some embodiments, motion data may be derived from forces measured on the vehicle (e.g., via force sensors such as stain gauges). In some embodiments, vehicle motion data may be obtained from a single vehicle traversing a road segment one or more times. In other embodiments, vehicle motion data may be obtained from a plurality of vehicles traversing one or more road segments one or more times (e.g., crowd sourced). In some embodiments, a vehicle or a plurality of vehicles may upload vehicle motion data to a cloud service or server for aggregation and further preprocessing.

According to exemplary embodiments described herein, vehicle motion profiles may be obtained from a plurality of vehicles, and the plurality of vehicles may have different types. In some cases, the type of vehicle may affect its vehicle motion profile. For example, the total mass of the vehicle, wheel mass, suspension tuning (e.g., damping, spring constant), or other parameters may affect a measured vehicle motion profile as the vehicle traverses a road segment. Accordingly, the inventors have appreciated that in some embodiments it may be desirable to normalize vehicle motion profiles to at least partially account for the differences between motion profiles based solely on differences between vehicle types. Additionally, in some embodiments, the inventors have appreciated that it may be desirable to filter a vehicle motion profile to reduce artifacts of wheel hop from a vehicle motion profile. In some embodiments, the inventors have appreciated that it may be desirable to filter a vehicle motion profile to reduce artifacts of low frequency vehicle body motion from a vehicle motion profile. In some methods according to exemplary embodiments described herein, a vehicle motion profile may be filtered in a frequency band (e.g., including a target frequency). In some embodiments, a filter may include a notch filter, where a stop-band frequency range of the notch filter includes the frequency band and target frequency. In some embodiments, a filter may include a low-pass filter, where a cutoff frequency of the low-pass filter is less than the frequency band and target frequency. In some embodiments, a filter may include a high pass filter, where a cutoff frequency of the high-pass filter is above the frequency band and target frequency. In some embodiments, the filtered frequency band may be between 10 and 15 Hz. Such a frequency band may correspond to a common frequency of wheel-hop. In some embodiments, the filtered frequency band may be between 0 and 3 Hz, which may correspond to low frequency vehicle chassis motion. In some embodiments, multiple filters may be employed in any combination, as the present disclosure is not so limited. In some embodiments, a vehicle motion profile may have frequencies between 5 and 30 Hz after filtering. Of course, any suitable frequencies may be employed for a vehicle motion profile, as the present disclosure is not so limited. In some embodiments, a vehicle motion profile may be transformed (e.g., using a Fourier transform) from one domain to another. In some embodiments, vehicle motion profile may be transformed from a time domain to a distance or frequency domain. For example, the time data may be multiplied by a known velocity value to obtain distance data. Such transformations may allow for easier procession of a vehicle motion profile associated with a particular road segment. Of course, any suitable domain for processing may be employed, as the present disclosure is not so limited.

According to exemplary embodiments described herein, a vehicle may include one or more wheels and one or more vehicle systems that are controlled by a vehicle control system. A vehicle control system may be operated by one or more processors. The one or more processors may be configured to execute computer readable instructions stored in volatile or non-volatile computer readable memory that when executed perform any of the methods disclosed herein. The one or more processors may communicate with one or more actuators associated with various systems of the vehicle (e.g., braking system, active or semi-active suspension system, driver assistance system, etc.) to control activation, movement, or other operating parameters of the various systems of the vehicle. The one or more processors may receive information from one or more sensors that provide feedback regarding the various portions of the vehicle. For example, the one or more processors may receive location information regarding the vehicle from a Global Navigation Satellite System (GNSS) such as a global positioning system, relative localization system, or other positioning system. The sensors on board the vehicle may include, but are not limited to, accelerometers, wheel rotation speed sensors, inertial measurement units (IMUs), optical sensors (e.g., cameras, LIDAR), radar, suspension position sensors, gyroscopes, etc. In this manner, the vehicle control system may implement proportional control, integral control, derivative control, a combination thereof (e.g., PID control), or other control strategies of various systems of the vehicle. Other feedback or feedforward control schemes are also contemplated, and the present disclosure is not limited in this regard. Any suitable sensors in any desirable quantities may be employed to provide feedback information to the one or more processors. It should be noted that while exemplary embodiments described herein may be described with reference to a single processor, any suitable number of processors may be employed as a part of a vehicle, as the present disclosure is not so limited.

According to exemplary embodiments described herein, one or more processors of a vehicle may also communicate with other controllers, computers, and/or processors on a local area network, wide area network, or internet using an appropriate wireless or wired communication protocol. For example, one or more processors of a vehicle may communicate wirelessly using any suitable protocol, including, but not limited to, WiFi, GSM, GPRS, EDGE, HSPA, CDMA, and UMTS. Of course, any suitable communication protocol may be employed, as the present disclosure is not so limited. For example, the one or more processors may communicate with one or more servers from which the one or more processors may access road feature information. In some embodiments, one or more servers may include one more server processors configured to communicate in two-way communication with one or more vehicles. The one or more servers may be configured to receive vehicle motion information from the one or more vehicles, and store and/or utilize that vehicle motion information to identify road features and/or road feature characteristics. The one or more servers may also be configured to send road feature locations and/or road feature characteristics to one or more vehicles, such that a vehicle may employ proactive vehicle control according to exemplary embodiments described herein.

In some embodiments, in order to mitigate adverse effects arising from traversal of road features, a vehicle may be designed to proactively adjust its behavior or the behavior of one or more systems in the vehicle, in preparation of interacting with an upcoming road feature. For example, one or more parameters of the vehicle (e.g., spring constants, damping coefficients, etc.) may be modified prior to a wheel of the vehicle encountering the road feature. Such proactive control may require some information about the road surface ahead of the vehicle. In some embodiments, this information may be collected using a look-ahead sensor such as, for example, a camera or LIDAR sensor that observes the road surface ahead of the wheels of the vehicle and is able to identify an upcoming road feature. However, cameras and similar look-ahead sensors may be face various limitations including, for example, obstructions in lines of sight (e.g., due to traffic), low visibility conditions (e.g., due to night-time or poor weather driving), resolution, and other limitations.

In some embodiments, in addition to, or instead of, using a look-ahead sensor, proactive vehicle control may make use of geographical locations (e.g., a map) of known road features (e.g., in a database). For example, if a current location and a travel direction of a vehicle is known, its forward path may be predicted. According to this example, the vehicle may then query a database including a map comprising locations of known road features to determine if the predicted forward path traverses any location of a known road feature. The vehicle may be controlled based on whether it is expected that the vehicle is going to encounter a road feature on the forward path. In some embodiments, a map may also include additional information about a given road feature, including, for example, type of feature (e.g., pothole, manhole cover, storm grate, speed bump), and its characteristics such as for example its size (e.g., length, width, height and/or depth), duration, curvature, etc. The vehicle may then adjust one or more vehicular parameters (e.g., one or more parameters of a controllable suspension system) in preparation for traversal of the road feature. In some embodiments, if the vehicle is being driven, the vehicle may prompt the driver to take a course of action. Alternatively, for example, if the vehicle includes a semi-autonomous or autonomous steering system, the steering system may alter the path of the vehicle such that the road feature is avoided. In some embodiments, the vehicle may apply active forces to the vehicle (e.g., via a semi-active or active suspension system, braking system, or traction control system) to compensate for the expected road feature encounter.

According to exemplary embodiments described herein, a road feature may be a component of a road surface that generates a measurable motion response by a vehicle when traversed by the vehicle. A road feature may include, but is not limited to road surface anomalies including, but not limited to potholes, bumps, surface cracks, expansion joints, frost heaves, rough patches, rumble strips, storm grates, etc.; and/or road surface properties, including but not limited to road surface texture, road surface composition, surface camber, surface slope, etc. Road features may have one or more road feature characteristics, which may also affect the measurable motion response of a vehicle traversing the road feature. Such road feature characteristics may include, but are not limited to, type (e.g., any of the listed road features above, length, width, depth, direction of vehicle motion response (e.g., positive such as a bump or negative such as a hole), duration, intensity, frequency response when encountered by a wheel, etc. Of course, any suitable characteristics may be associated with a road feature, as the present disclosure is not so limited.

According to exemplary embodiments described herein, the location of a vehicle may be estimated or at least partially determined by, for example, absolute localization systems such as satellite-based systems. Such systems may be used to provide, for example, absolute geocoordinates (i.e., geographic coordinates on the surface of the earth such as longitude, latitude, and/or altitude) of a vehicle, which may be associated with vehicle motion at those geocoordinates. Satellite based systems, generally referred to as a Global Navigation Satellite System (GNSS), may include a satellite constellation that provides positioning, navigation, and timing (PNT) services on a global or regional basis. While the US based GPS is the most prevalent GNSS, other nations are fielding, or have fielded, their own systems to provide complementary or independent PNT capability. These include, for example: BeiDou/BDS (China), Galileo (Europe), GLONASS (Russia), IRNSS/NavIC (India) and QZSS (Japan). Systems and methods according to exemplary embodiments described herein may employ any suitable GNSS, as the present disclosure is not so limited.

According to exemplary embodiments described herein, dead reckoning may either be used to determine a location of the vehicle at a time point after the vehicle's last known location using the vehicle's measured path of travel and/or displacement from the known location. For example, the distance and direction of travel may be used to determine a path of travel from the known location of the vehicle to determine a current location of the vehicle. Appropriate inputs that may be used to determine a change in location of the vehicle after the last known location of the vehicle may include, but are not limited to, inertial measurement units (IMUs), accelerometers, sensor on steering systems, wheel angle sensors, relative offsets in measured GNSS locations between different time points, and/or any other appropriate sensors and/or inputs that may be used to determine the relative movement of a vehicle on the road surface relative to a previous known location of the vehicle. This general description of dead reckoning may be used with any of the embodiments described herein to determine a location of the vehicle for use with the methods and/or systems disclosed herein.

According to exemplary embodiments described herein, vehicle motion data and/or trained statistical models may be stored in one or more databases onboard a vehicle and/or in one or more remotely located servers. In some embodiments, a database may be contained in non-transitory computer readable memory. In some embodiments, the database may be stored in memory that is exclusively or partially located remotely (e.g., as a part of a cloud service) from the vehicle, and the database and the vehicle may exchange information via a wireless network (e.g., a cellular network such as 5G or 4G, WiFi, etc.). Alternatively, in some embodiments, the database may be stored in non-transitory memory that is located on the vehicle. In some embodiments, methods according to exemplary embodiments described herein may be implemented as programming instructions stored on at least one non-transitory computer-readable storage medium, where the programming instructions are configured to be executed by at least one processor to perform a method. In some embodiments, multiple processors may be employed to perform a method (e.g., as a part of a cloud service or multiple servers). In some embodiments, one or more servers may obtain vehicle motion data from one or more vehicles and may perform the methods described herein to identify one or more road features and/or road feature characteristics. In some embodiments, the one or more servers may transmit the identified one or more road features and/or road feature characteristic to one or more vehicles.

In some embodiments, before applying a trained statistical model to a new dataset, vehicle motion profiles may be split into segments equal to the size of the segments employed to train the statistical model. The segmentation of the motion profiles may ensure that an entire road feature may be captured within a segment. Since road features may be found in any segment of a motion profile, the segmentation may be dynamic and not fixed. In some embodiments, sliding window techniques may be employed in exemplary methods described herein, where a moving window of a specified length slides along the motion profile by a specified step length, where each step length is a segment. In this way, overlapping vehicle motion profiles may be provided to ensure that a segment will not miss a part of the road feature. However, such a method may cause multiple segments to include the same road feature. Accordingly, in some embodiments, neighboring segments may be filtered out to a single segment per road feature using a statistical metric (e.g., root mean square). For example, a segment with the highest root mean square value among the 5, or other appropriate number of, neighboring segments may be selected as a representative segment. Once the selected segments are obtained, their corresponding input feature space may be generated for which the trained model will predict classes or clusters.

According to exemplary embodiments described herein, a machine learning model (e.g., a trained statistical model) uses a multi-dimensional space of features (machine learning features not to be confused with the road features mentioned herein) as input. A machine learning feature is an individual independent variable which is extracted from the data. The number of these independent variables is the number of the dimensions of the input feature space. The higher the dimension of the feature space the higher is the complexity that the statistical model needs to consider and resolve. In exemplary embodiments herein, a machine learning feature may be a variable extracted from a motion profile (or a linear/non-linear combination of multiple motion profiles). For instance, in some embodiments such a variable may be the root mean square value, the integral, the signal energy, or the min-to-max amplitude of a motion profile over a certain time period. In some embodiments, a variable may also be the amplitude of the Fast Fourier Transform at a certain frequency of a motion profile, or a measure of the shape (e.g., skewness, kurtosis, etc.) of a motion profile or its transformation into another domain (e.g., frequency domain). Thus, the feature extraction may affect the performance, efficiency, robustness, and computational power of a trained statistical model. These machine learning features may be implemented using any appropriate statistical model as described herein.

In some embodiments, once an input feature space is established, the types of road features for detection are identified (e.g., pothole, speedbump, etc.). In some embodiments, each type of a road feature may represent a class, or a previously identified cluster, in the machine learning context. In some embodiments, vehicle motion data that do not contain any road feature or contain a road feature of a type that is not of interest may represent a separate individual class. Thus, in some embodiments, a trained statistical model may be a binary or a multi-class trained statistical model.

In some embodiments, a class to which each individual data point (e.g., vehicle motion profile, vehicle motion profile segment, etc.) belongs to (i.e., labels) may be provided. In some embodiments, a single data point may be represented by a set of machine learning features as described above. In some cases, identifying the class of each data point (i.e., labeling) may be a rigorous process especially if the data size is large. In some embodiments, a labeled dataset (also known as ground truth data) may be produced from vehicle motion profiles of a portion of a vehicle that were obtained from vehicles that have traversed road features of interest with a known location. In some embodiments, a camera-based system may be employed to automate this process where video or pictures are used to identify the desired road features and then label the corresponding motion profiles accordingly. Though other methods of identifying and labeling may also be used.

In some embodiments, once a labeled dataset of vehicle motion profiles is obtained, a statistical model may be trained using the labeled dataset in order to predict road features similar to the reference road features of the labeled dataset. In some embodiments, the trained statistical model may receive any unlabeled dataset where the class of each data point is unknown as input, and output labeled data points according to the classes provided in the labeled dataset. Thus, from a relatively small set of known road features, road features of the same or similar type in new vehicle motion profiles may be identified and classified using the trained statistical model. In some embodiments, the location associated with any vehicle motion profile may be determined based on a synchronized location determined using a localization method (e.g., GNSS, terrain-based, lane identification, dead reckoning, etc.) may be known, and this location information may be employed with the trained statistical model so that the location of unknown road features similar to the reference road feature may be determined at scale.

In some embodiments, training a statistical model may dictate the performance of the model in predicting correct classes in the new datasets. Hence, in some embodiments, a model's performance may be evaluated during a training process before applying the model to a new dataset where ground truth is unknown. In some embodiments, a labeled dataset may be randomly split into a training dataset and a test dataset (e.g., 70% training and 30% test, 80% training vs 20% test, or other appropriate split). This method may be referred to as a “holdout”, and the test percentage may be based on the variance and/or size of the data. The training dataset may be used to train the model and apply any additional optimization technique (e.g., feature selection algorithms), whereas the test dataset may be used to evaluate the performance of the resulting model. According to some such embodiments, the performance achieved in the test dataset may be similar with the performance that would be achieved in a new unlabeled dataset, under the assumption that the test dataset and the new dataset are similar. Accordingly, such a test may be predictive for the accuracy of the trained statistical model with new, unlabeled datasets. In some embodiments, the holdout method may be employed multiple times with different split combinations between training and test data, and the performance of the model for all the different split combinations may be compared.

According to exemplary embodiments described herein, a training dataset (e.g., labeled vehicle motion profiles, clustered vehicle motion profiles, etc.) is used to fit a trained statistical model. Fitting a model to a dataset is the process where the model parameters (known as “hyperparameters”) are manually or automatically tuned in order to achieve a sufficient classification performance and an output model that can be generalized to similar data. Depending on the model there may be several algorithms that are used to converge to the optimal set of the hyperparameters. The inventors have appreciated that one of the main challenges in this process is to address overfitting, where a model performs well in the training dataset but poorly in other datasets. To avoid overfitting, in some embodiments the training dataset may be split into k equal parts (also known as “folds”). In some embodiments, a first fold is kept as a holdout set to evaluate the performance of the model, whereas the remaining k−1 folds are used to train the model. According to such embodiments, the trained model is then discarded and only the performance score is kept. The above process is repeated k times when each time the fold being kept for holdout is changing. All the performance scores are then aggregated into a single performance score which is way more representative to the actual classification performance of the final model (which is actually trained using the entire training dataset). This method is called k-fold cross validation and it may be independently combined with the holdout method described herein.

According to exemplary embodiments described herein, different families of classifiers may be employed for statistical models. Decision trees, support vector machines (SVM), naïve bayes classifiers, K-nearest neighbor classifiers (KNN), artificial neural networks (NN), and discriminant analysis classifiers are some examples of classifiers that may be employed. In addition, deep learning models may be also used as classifiers such as convolution neural networks (CNN) and long short-term memory networks (LSTM).

In some embodiments, to improve performance against bias, variance, and noise, instead of exploiting a single model an ensemble of multiple models of the same or different type may be employed. An ensemble aggregates results from multiple dependent or independent models (e.g., weak learners) to derive a final prediction or a final model (e.g., strong classifier). Ensembles may be categorized based on their aggregation algorithm as boosting, bagging, and stacking. In the bagging method an ensemble combines the results of similar independent weak learners, which operate in parallel, via a deterministic voting rule. One such bagging method is the Bootstrapping method. In the boosting method each weak learner will learn from the mistakes (e.g., classification error) of the previous weak learner. The weak learners operate sequentially, and the outcome is a final optimized strong classifier. Gradient boosting, Adaptive Boosting (AdaBoost), and XGBoost (Extreme Gradient Boosting) are few boosting ensemble techniques. Of course, any suitable classifier or ensemble may be employed in statistical models described herein, as the present disclosure is not so limited.

According to exemplary embodiments described herein, a method may include identifying and outputting a road feature and/or one or more road feature characteristics associated with the road feature using one or more trained statistical models. In some embodiments, a method may include controlling a vehicle based on the identified road feature and/or one or more road feature characteristics. For example, if the road feature includes a long duration (e.g., uneven lane, low-friction surface, etc.), the vehicle may be controlled reactively once the trained statistical model identifies the road feature and/or one or more road feature characteristics. In this manner, the method may reactively improve vehicle control and/or handling as the vehicle may be able to determine road feature characteristics such as type and duration while traversing the road feature.

According to exemplary embodiments described herein, a method may include associating a road feature and/or one or more road feature characteristics with one or more geographical locations. In some embodiments, the road features and associated one or more geographical locations may be employed to generate a map. In some embodiments, the map may be provided to an organization such as a government, government agency, company (e.g., trucking fleet, bus fleet, mapping company), or telematics company who may have use for the road feature information. For example, such information may be useful for public works departments to formulate road work and repair. As another example, such information may be useful to a mapping company that may provide real-time warnings to drivers. In some embodiments, detection of a new road feature or detection of a change in a road feature characteristic may be employed to update a map. Of course, in other embodiments road feature location and characteristic information may be provided and used in any format, including as a searchable database or application programming interface (API), as the present disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

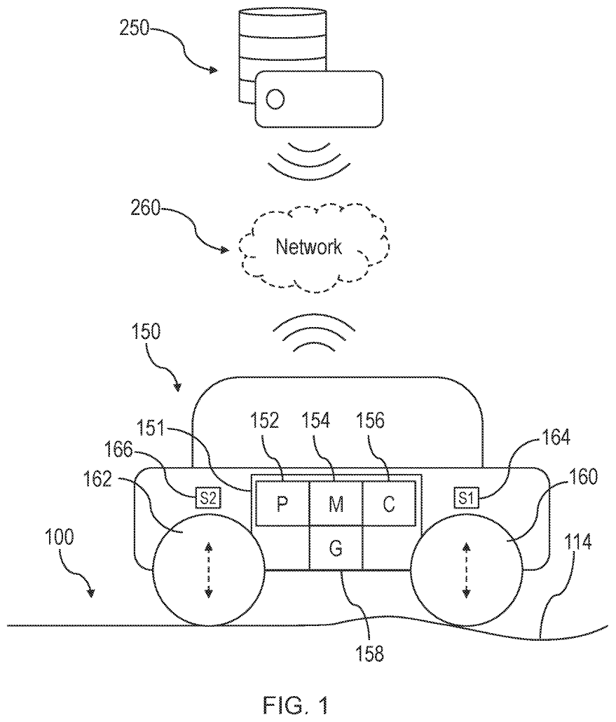

FIG. 1 depicts a schematic of an embodiment of a vehicle 150. The vehicle 150 may be employed in various methods according to exemplary embodiments described herein. As shown in FIG. 1, the vehicle includes a vehicle control system 151 which is configured to control one or more systems of the vehicle. In some embodiments as shown in FIG. 1, the vehicle control system includes one or more processors 152, non-transitory computer readable memory 154 associated with the one or more processors, and a communications module 156. The processor may be configured to execute computer readable instructions stored in the non-transitory computer readable memory to perform various methods described herein, and to control various systems of the vehicle. The communications module 156 may be a wireless communications module configured to allow the vehicle control system to communicate with remote devices (e.g., other vehicles, a server, the internet, etc.). The communications module 156 may employ any suitable wireless communication protocol. In some embodiments, the communications module 156 may be configured for two-way communication with a remote device such that the communications module may send and/or receive information. According to some embodiments as shown in FIG. 1, the vehicle 150 may include a localization system 158 such as a Global Navigation Satellite System receiver (GNSS receiver), a relative localization system, a terrain localization system, and/or any other system configured to estimate a location of the vehicle, which may in turn be used to localize an identified road feature using the location of the vehicle at the time the road feature was encountered by the vehicle.

According to the embodiment of FIG. 1, the vehicle 150 includes wheels 160, 162 which traverse a road 100 having road features 114. The vehicle 150 includes one or more sensors associated with various portions of the vehicle, such as the depicted first sensor 164 and second sensor 166 configured to measure displacement of the wheels to measure the motion of the vehicle 150 as it traverses the road 100. For example, the first sensor 164 and second sensor 166 may be accelerometers configured to measure acceleration of the wheels (e.g., vertical wheel acceleration). However, different types of sensors associated with different portions of the vehicle may be used to measure a vehicle motion profile as previously described. Regardless of the specific sensor(s) used, the measured information from the sensor(s) may be transmitted to the processors 152, which may aggregate the sensor signals to form a vehicle road profile.

According to the embodiment of FIG. 1, the vehicle 150 is configured to communicate with one or more remote servers, other vehicles, and/or any other appropriate system via communications module 156. In some embodiments as shown in FIG. 1, the communications module 156 may communicate via a network 260 (e.g., a local area network, wide area network, internet, etc.) to a server 250. The communications module may send information (e.g., vehicle motion profile information, location information, etc.) to the server 250, and the communications module may receive information (e.g., road feature locations, road feature characteristics, etc.) from the server. While in the embodiment of FIG. 1 the vehicle is communicating with a single server, a vehicle may communicate with any number of servers or other remote devices, as the present disclosure is not so limited. In some embodiments, the server may include a database of road feature information for a road network. Additionally, in some embodiments, the server may be configured to perform one or more methods described herein to identify additional road features and/or road feature characteristics using a trained statistical model. The trained statistical model may be stored on the server 250.

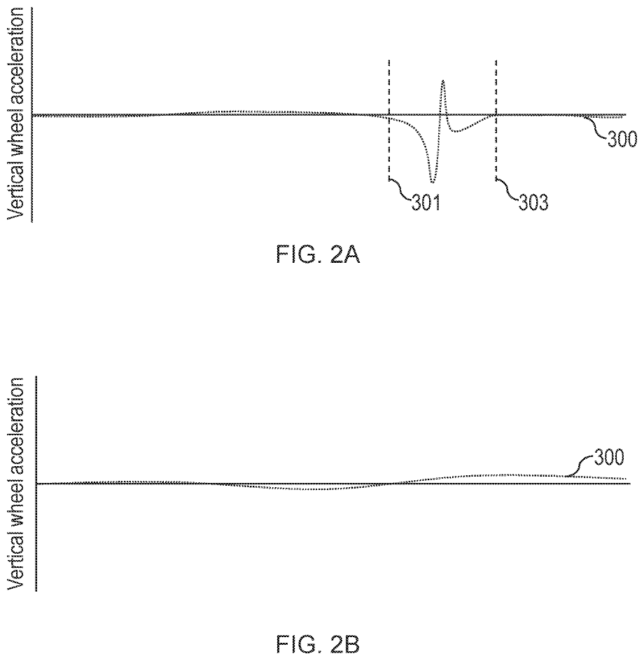

FIG. 2A depicts an exemplary chart showing a first embodiment of vertical wheel acceleration 300 of a vehicle. As discussed above, vertical wheel acceleration may constitute or may form a part of a vehicle motion profile. According to the profile shown in FIG. 2A, a road feature is denoted by start line 301 and end line 303. Between the start line and end line, the wheel acceleration exhibits a sudden drop (e.g., negative acceleration) followed by a spike to positive acceleration, before returning to approximately zero. Such a profile may correspond to the wheel encountering a pothole. As shown in FIG. 2A, the response of the wheel to the pothole is clearly distinguished from normal vertical wheel acceleration over time. As shown in FIG. 2A, the acceleration is down in the time domain. However, in some embodiments, the wheel acceleration may be transformed to the frequency domain, which would show a high frequency response corresponding to the pothole encounter. As discussed above, in some embodiments data like that shown in FIG. 2A may be filtered to attenuate undesired frequencies that may be influenced by specific vehicle parameters or known vehicle dynamics (e.g., wheel hop).

According to the embodiment of FIG. 2A, the specific response shown between start line 301 and end line 303 may be associated with one or more road feature characteristics. For example, the time between start line 301 and end line 303 may be a road feature duration. As another example, the specific response of negative acceleration, followed by positive acceleration, may correspond to a pothole road feature type. Of course, any suitable road feature characteristic may be identified from a vehicle motion profile, as the present disclosure is not so limited.

FIG. 2B depicts an exemplary chart showing a second embodiment of vertical wheel acceleration 300 of a vehicle. According to the profile shown in FIG. 2B, the wheel acceleration does not include a road feature. However, as shown in FIG. 2B, there is still some normal variation in vertical wheel acceleration associated with traversal of a road segment. This vertical wheel acceleration may have a relatively low frequency, which may be filtered out by a high-pass filter in some embodiments. According to the embodiments of FIGS. 2A-2B, the vertical wheel acceleration of FIG. 2A may be employed as training data for the presence of a road feature (after optional preprocessing), whereas the vertical wheel acceleration of FIG. 2B may be employed as training data for the absence of a road feature (after optional preprocessing). In some embodiments, the vertical wheel acceleration shown in FIGS. 2A-2B may be input to a trained statistical model which may identify a road feature in the case of FIG. 2A and may identify an absence of a road feature in the case of FIG. 2B.

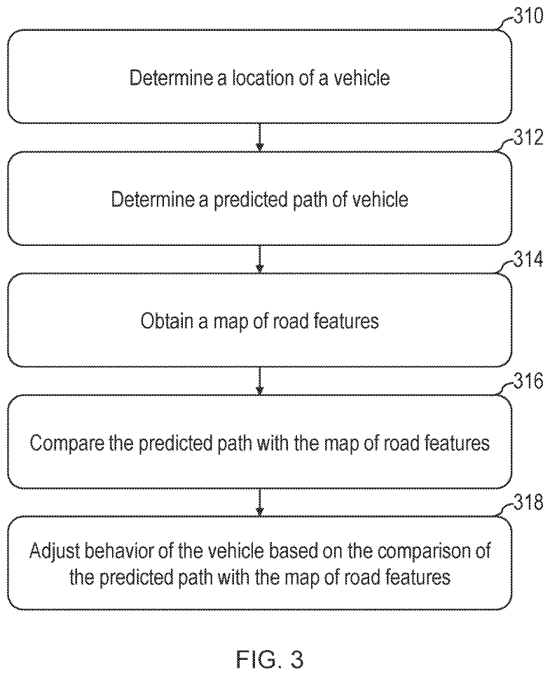

FIG. 3 depicts a flow chart of an exemplary embodiment of a method for proactively controlling a vehicle. In block 310, a location of the vehicle and travel information of the vehicle is determined. The location of the vehicle may be determined by a localization system such as, for example, a global positioning system (GPS), terrain-based localization, a lane-identification system, dead reckoning system, etc. In some embodiments, accuracy and/or resolution of a location provided by GPS alone may be insufficient, and so GPS may be combined with another localization system (e.g., terrain-based localization, a lane-identification system, dead reckoning system, etc.) or otherwise modified (e.g., by use of real-time kinematic positioning) to increase the accuracy and/or resolution to the determined location. In addition to the location of the vehicle, in some embodiments travel information of the vehicle may be determined. This travel information may include, for example, a direction of travel of the vehicle and/or a speed of travel of the vehicle.

As shown in block 312 of FIG. 3, based on the location of the vehicle and the travel information, a predicted path of the vehicle may be determined. In some embodiments, determining the predicted path of a vehicle may further include accessing a map (e.g., from a server) containing road data such that the location and/or travel information may be correlated to a given road. For example, if a location of a vehicle is determined to lie along a given road (e.g., Main St.), and the travel direction indicates travel in a given direction (e.g., westward on Main St.), then the predicted path may correspond to continued travel in the given direction on the given road (e.g., the predicted path may be continued westward travel on Main St.). In some embodiments, historical data may be used to determine the predicted path. For example, if a substantial percentage, such as 90%, of past vehicles at a given location with a given travel direction follow the same path, then it may be predicted that the vehicle will follow the same path. In some embodiments, path prediction may account for a time of day or time of year. For example, during times associated with a morning commute, vehicles may generally follow a path that is different than during times associated with an evening commute or weekend outing. Further, in some embodiments, path prediction may account for occurrence of an event (e.g., on a day of a football game, it may be predicted that vehicles are more likely to take a path associated with arrival to a football stadium than on a day in which there is no football game). In some embodiments, the determining the predicted path may include using a lane-identification system to identify a lane in which the vehicle is travelling. For example, if the vehicle is determined to be travelling in the left-most lane of a road, the predicted path may coincide with further travel in the left-most lane of the road.

As shown in block 314 of FIG. 3, once the predicted path of the vehicle is determined, a map of road features may be accessed. In some embodiments, the map includes at least a set of road features and a geographical location of each road feature. The location of each road feature may be stored in absolute geographic coordinates, or it may be stored as a relative position of the road feature on a given road (e.g., a road feature may be recorded as existing in “the left lane at mile 93.41 of I-95”). The map may further include additional information about each road feature (e.g., road feature characteristics), including, for example, a type of road feature (e.g., speed bump, pothole, manhole cover, storm grate, crack, etc.), magnitude, duration, curvature of each road feature, and/or any other suitable road feature characteristic as discussed herein. The map may further include information about how one or more vehicles have treated each feature in the past (e.g., one or more adjustments that vehicles have made to mitigate an effect of each feature). In some embodiments, the map may be stored as a database or table and, optionally, may be located remotely from the vehicle (e.g., in one or more servers). In such embodiments, a vehicle may download the map, database, table, and/or a portion thereof to access the information. In some embodiments, the vehicle may display the map and/or road feature information to a user of the vehicle. In such embodiments, the road feature information may be employed to warn the user of an approaching hazard along the predicted path.

As shown in block 316 of FIG. 3, the predicted path of the vehicle may be compared with one or more locations of road features collected from the map of road features. If it is determined that the predicted path includes a location of a road feature, then one or more operating parameters of the vehicle or a vehicle system (e.g., a damping coefficient or spring constant of an adjustable suspension system) may be proactively adjusted in preparation of traversal of the road feature in block 318. In some embodiments, an operating speed of the vehicle may be used to determine, for example, a predicted time of the start traversal of the road feature, and the adjustment may occur at some point prior to or at the predicted time. In some embodiments, adjusting a vehicle behavior may include applying an active force to the vehicle (e.g., braking, active suspension force, etc.) to proactively compensate for the road feature on the predicted path. As noted above, the map used to provide the road feature locations may be compiled, and potentially updated either in real time or at predetermined intervals, using the methods and systems disclosed herein.

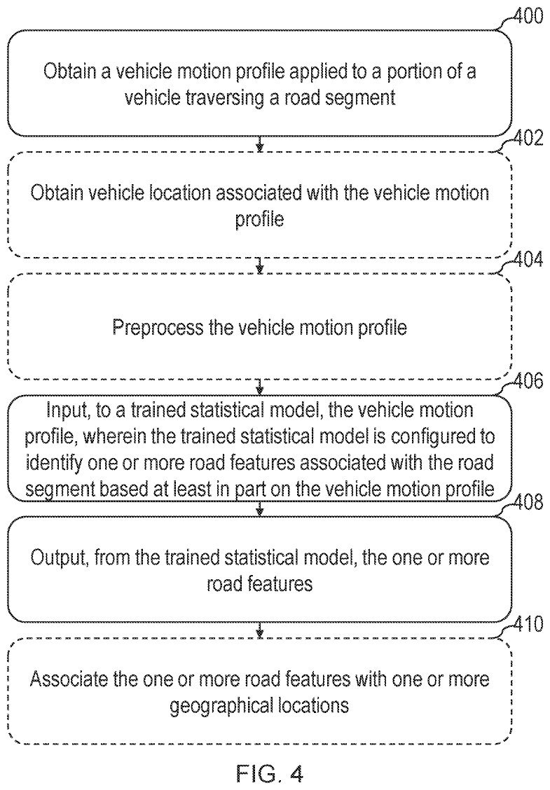

FIG. 4 is a flow chart for one embodiment of a method of determining the presence of a road feature using a vehicle motion profile. In block 400, a vehicle motion profile is obtained that is indicative of motion of one or more portions (e.g., a single portion) of the vehicle as the vehicle traverses a road segment. For example, the motion profile or other related profiles may correspond to, for example, vertical, longitudinal, or angular motion of a wheel of the vehicle. As another example, the motion profile may correspond to vertical, longitudinal, or lateral motion of another portion of the unsprung mass of the vehicle. As still another example, the motion profile may correspond to vertical, lateral, or longitudinal motion of a portion of the sprung mass of a vehicle such as, for example, a portion of a body of the vehicle. Of course, a motion profile may also correspond to a combination of all the above, as the present disclosure is not so limited. In some embodiments, the motion profile may be obtained using one or more motion sensors (e.g., accelerometers, suspension position sensors, inertial measurement units (IMUs)) that are arranged to sense motion of the one or more portions of the vehicle. These one or more motion sensors may measure motion as the vehicle traverses a road segment.

According to some embodiments, a vehicle motion profile information may be obtained through real-time measurement of vehicle motion as the vehicle traverses the road segment. In other embodiments, a vehicle motion profile may be obtained through recall of prior measurements of vehicle motion. Such prior measurements may be stored in non-volatile memory (e.g., on one or more servers) and accessed later. In some embodiments, both real-time information and stored information from prior traversals may be employed in exemplary methods described herein, as the present disclosure is not so limited.

As shown in optional block 402, in some embodiments the method includes obtaining a vehicle location associated with the vehicle motion profile. In some embodiments, the location may be obtained by the vehicle, which may collect location information that tracks a location of the vehicle as the vehicle traverses the road surface. The location information may be obtained using any appropriate localization system(s) (e.g., a GNSS, a terrain-based localization system, a lane-identification system, a dead-reckoning system, etc.).

As shown in optional block 404, the vehicle motion profile may be preprocessed (e.g., filtered, transformed, integrated, differentiated, compressed, combined with motion data from another portion of the vehicle, normalized, windowed or any combination or permutation thereof). In some embodiments, preprocessing the vehicle motion profile may include filtering the vehicle motion profile. In some embodiments, the filtering of the motion profile includes attenuating vehicle-specific effects (e.g., attenuating artifacts of wheel hop by applying a band-pass filter).

In some embodiments, preprocessing the vehicle motion profile may include segmenting or cutting the vehicle motion profile appropriately (e.g., employing windowing techniques) in order to appropriately size segments of vehicle motion profiles for use with a trained statistical model. In some embodiments, a route traversed by the vehicle may be separated into road segments, and each road segment may be associated with both a respective location, as determined in block 402, and with a respective motion profile. In some embodiments, each road segment may correspond to a constant distance of travel (e.g., if a vehicle travels 1000 feet, it may be split into 100 separate road segments corresponding to a distance of 10 feet each), or alternatively may correspond to a constant time of travel (for example, each road segment may correspond to 30 seconds of travel). In some embodiments, road segments may overlap with one or more preceding or proceeding road segments. The respective motion profile that is associated with a given road segment may be indicative of the motion of a portion of the vehicle as the vehicle traversed the given road segment. Thus, in some embodiments, a set of vehicle motion profiles may be obtained, where each motion profile of the set is associated with traversal of a specific segment.

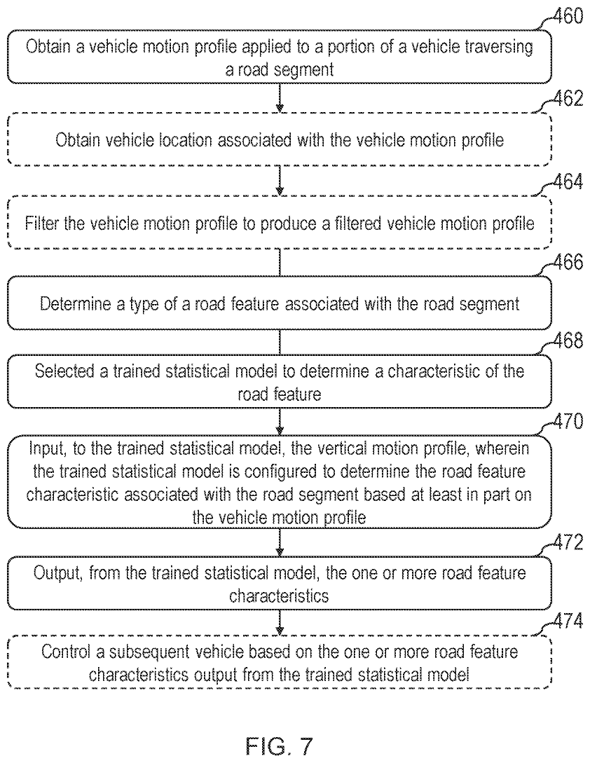

After any optional preprocessing of the vehicle motion profile, the vehicle motion profile may be analyzed to identify the presence of a road feature. In particular, as shown in block 406, the vehicle motion profile is input to a trained statistical model, where the trained statistical model is configured to identify one or more road features associated with the road segment based at least in part on the vehicle motion profile. If the trained statistical model identifies the presence of a road feature, the trained statistical model may output the one or more road features as shown in block 408. In some embodiments, outputting may include communicating the one or more road features to a remote system (e.g., a server, vehicle, etc.). In some embodiments, outputting may include use of the one or more road features by another system (e.g., a server, vehicle, etc.). In some embodiments, outputting may include saving the one or more road features to memory (e.g., non-volatile memory). In some embodiments, outputting may include any combination of communicating, using, and saving the one or more road features, as the present disclosure is not so limited. In some embodiments, the corresponding obtained location information from optional block 402 may be used to determine a location of the road feature and/or a location of the segment containing the road feature. In optional block 410, the one or more road features may be associated with one or more geographical locations. This location may be expressed either as absolute coordinates or as a relative position on a road traversed by the vehicle. The location and optionally additional information about the road feature (e.g., a type of the road feature, information about one or more dimensions or other characteristics of the road feature) may then be stored in a map (e.g., a database). The database may be on board a vehicle or be a part of a remote server. As discussed further below with reference to FIG. 7, such road feature information may also be identified by a trained statistical model (e.g., a second trained statistical model). The map may be an electronic map that is stored (e.g., as a database) in non-volatile computer readable memory.

In some embodiments, a trained statistical model may identify the presence of a road feature based on the parameters of the vehicle motion profile. For example, if it is determined that a parameter indicative of traversal of a given type of road feature is present in a given motion profile, then it may be assumed that the segment associated with the given motion profile includes the given type of road feature. Correspondingly, if no parameter indicative of traversal of a given type of road feature is identified in the motion profile, then it can be determined that the segment traversed by the vehicle does not include any road feature of the given type.

In some embodiments, parameters indicative of traversal of a road feature may include a specific sequence of movements, or may include any other parameter including, but not limited to, significant observed motion in certain frequencies ranges relative to other frequency ranges, absence or effective absence of motion in certain frequency ranges, and large peak accelerations. For example, traversing a speed bump may cause a wheel of the vehicle to move sharply upward at the start of the bump, followed by downward at the end of the bump. Therefore, if a vehicle motion profile is indicative of a sharp upward movement of a wheel followed by a downward movement of the wheel, then it may be concluded that the segment that is associated with the obtained vehicle motion profile includes a bump (e.g., a speed bump). Vehicle motion profile parameters indicative of a road feature may also include linear or non-linear combinations of various data features. For example, a larger ratio of motion in a first frequency range as compared to a second frequency range may be indicative of a certain type of road event. It is contemplated that, as the number of road features the system is designed to detect increases, parameters uniquely indicative of traversal of a particular type of road feature will involve more complex combinations of various features in the data. For example, distinguishing a segment that includes a bump from a segment that contains no discrete event may be relatively straightforward, while distinguishing a segment that includes a bump from a segment that includes a manhole cover may involve more complex parameters. Given this complexity, the inventors have recognized that it may be advantageous to train and utilize the trained statistical model to classify vehicle motion profiles. When a new vehicle motion profile is obtained, the trained statistical model may be used to classify the new motion profile as indicative of traversal of a road feature or the absence of such a road feature.

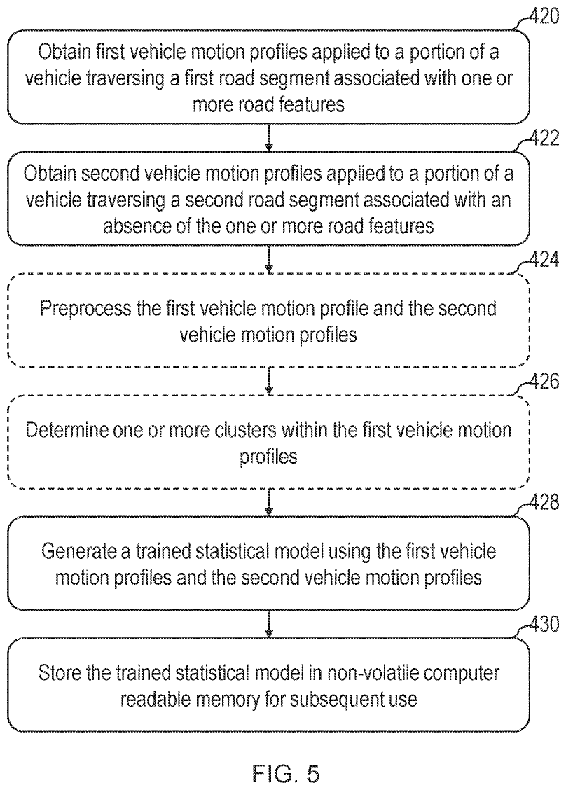

FIG. 5 illustrates a flow chart of an exemplary method of training a statistical model that can be used to classify motion profiles. In block 420, first vehicle motion profiles applied to a portion of a vehicle traversing a first road segment are obtained, where the first vehicle motion profiles are associated with one or more road features (e.g., a bump, pothole, manhole cover, storm grate, frost heave, etc.). In some embodiments, the first vehicle motion profiles may be selected manually based on locations of known road features of a first type. In some embodiments, the first vehicle motion profiles may correspond to a road segment on one or more test tracks that is constructed to include a road feature of a particular type. According to such an embodiment, each time the vehicle traverses the first road segment, a reference motion profile may be obtained to yield the first motion profiles. Of course, in other embodiments the first vehicle motion profiles may be obtained from a plurality of vehicles that may traverse a first road segment which may be a public road. In some such embodiments, the first vehicle motion profiles may be crowd-sourced from third party vehicles. In some embodiments, the first vehicle motion profiles may not correspond to the same physical road segment, by may correspond to a road segment type (e.g., different road segments each including the one or more road features). Each motion profile of the first vehicle motion profiles may be labeled as corresponding to traversal of the one or more road features (e.g., if the first reference road feature is a bump, then each reference motion profile of the first set may be labeled as corresponding to traversal of a bump).

In block 422, second vehicle motion profiles applied to a portion of a vehicle traversing a second road segment are obtained, where the second vehicle motion profiles are associated with an absence of the one or more road feature. In some embodiments, the second vehicle motion profiles may be selected manually based on locations known to lack road features. In some embodiments, the second vehicle motion profiles may correspond to a road segment on one or more test tracks that is constructed to lack a road feature. According to such an embodiment, each time the vehicle traverses the second road segment, a reference motion profile may be obtained to yield the second motion profiles. Of course, in other embodiments the second vehicle motion profiles may be obtained from a plurality of vehicles that may traverse a second road segment which may be a public road. In some such embodiments, the second vehicle motion profiles may be crowd-sourced from third party vehicles. In some embodiments, the second vehicle motion profiles may not correspond to the same physical road segment, by may correspond to a road segment type (e.g., different road segments each lacking the one or more road features). Each motion profile of the second vehicle motion profiles may be labeled as corresponding to traversal of no road features.

As shown in optional block 424, in some embodiments each vehicle motion profile of the first vehicle motion profiles may be subject to further data preprocessing (e.g., filtering, transforming, integrating, differentiating, windowing, etc.). In particular, as shown in FIG. 5, the first vehicle motion profiles may be filtered to produce first filtered vehicle motion profiles. Any suitable filter may be employed according to exemplary embodiments described herein to attenuate undesired portions of the vehicle motion profile, as the present disclosure is not so limited. In embodiments where block 424 is employed, the first filtered vehicle motion profiles may be employed in later steps of the method of FIG. 5.

As shown in optional block 424, in some embodiments each vehicle motion profile of the second vehicle motion profiles may be subject to further data preprocessing (e.g., filtering, transforming, integrating, differentiating, windowing, etc.). In particular, as shown in FIG. 5, the second vehicle motion profiles may be filtered to produce second filtered vehicle motion profiles. Any suitable filter may be employed according to exemplary embodiments described herein to attenuate undesired portions of the vehicle motion profile, as the present disclosure is not so limited. In embodiments where block 424 is employed, the second filtered vehicle motion profiles may be employed in later steps of the method of FIG. 5.

In some embodiments as shown in FIG. 5, in optional block 426 one or more clusters may be determined within the first vehicle motion profiles. In some embodiments, clustering the first vehicle motion profiles may include grouping the first vehicle motion profiles into a plurality of separate clusters of similar data points using a clustering algorithm. Each of the clusters may correspond to a different road feature. As discussed above, there may be no prior knowledge regarding which cluster a data point belongs to. In some embodiments, a clustering algorithm may be applied to the first vehicle motion profiles to cluster the first vehicle motion profiles into previously obtained clusters, thereby associated each of the first vehicle motion profiles with a previously obtained cluster (e.g., a stored cluster). In some embodiments, new clusters may be determined in block 426. A clustering algorithm may be any suitable clustering algorithm, including, but not limited to, K-means, gaussian mixture models (GMM), density-based spatial (DBSCAN), and hierarchical clustering.

In block 428, the first vehicle motion profiles and the second vehicle motion profiles may be used as training sets for a trained statistical model (e.g., a support vector machine, neural network, decision tree, etc.). That is, the first and second vehicle motion profiles are used to generate the trained statistical model. In some embodiments the trained statistical model compares the first vehicle motion profiles and the second vehicle motion profiles to identify one or more parameters that are uniquely present in the first vehicle profiles and therefore indicative of traversal of the first type of road feature. In this embodiment involving only comparison of one type of road feature versus an absence of a road feature, the trained statistical model serves as a binary classifier that is configured to classify a vehicle motion profile as indicative of either traversal of a road feature of the first type, or indicative of traversal of no road feature. When a new motion profile is obtained from traversal of a new road segment, the new motion profile may be evaluated by the trained statistical model to determine whether the new motion profile is indicative of traversal of a road feature of the first type or not. If it is indicative of traversal of a road feature of the first type, then it may be determined that the new road segment includes a road feature of the first type, otherwise, it may be determined that the new road segment does not include any road feature of the first type. As shown in block 430, the trained statistical model is stored in non-volatile computer readable memory for subsequent use with new vehicle motion profiles.

In some embodiments, a trained statistical may be trained to recognize more than one type of road feature, and/or to distinguish between types of road features (e.g., to distinguish traversal of a manhole cover from traversal of a speed bump). In these embodiments, in order to train the statistical model to recognize a second type of road feature, one or more vehicles may be driven over a third road segment, where the third road segment includes a road feature of a second type that is different from the first type. Each time the one or more vehicles traverse the third road segment, a third vehicle motion profile may be obtained, yielding third vehicle motion profiles. Each motion profile of the third vehicle motion profiles may be labeled as corresponding to traversal of a road feature of the second type. The third vehicle motion profiles may then serve as an additional training set for the trained statistical model in block 428, such that the statistical model is trained to identify characteristics that are uniquely indicative of traversal of the first type of road feature, uniquely indicative of traversal of the second type of road feature, or uniquely indicative of traversal of a segment having no discrete road feature. The statistical model may thus serve as a multi-class classifier. In some embodiments, the multiple classes may be identified using clustering as discussed above with reference to optional block 426. In some such embodiments, the third vehicle motion profiles may be a subset of the first vehicle motion profiles. In some embodiments, the statistical model may utilize a one versus one architecture, while in other embodiments it may utilize a one versus all architecture. In some embodiments, the statistical model may be a deep machine learning model (e.g., a deep neural network, a deep SVM), or an ensemble of machine learning models (e.g., ensemble of decision trees, ensemble of K-nearest neighbor models, etc.).

According to exemplary embodiments described above, measurements over a first road segment, second road segment, and third road segment are illustrative and should be understood to include measurements over multiple different road segments and/or multiple measurements of the same road segment. That is, vehicle motion profiles may be associated with the same physical road segment and/or may be associated with different road segments having similar road features.

In some embodiments, a second trained statistical model may be trained employing additional data sets including road features having different road feature characteristics. In some embodiments, third vehicle motion profiles may be associated with a first road feature characteristic, and fourth vehicle profiles may be associated with a second road feature characteristic. For example, a first road feature characteristic may include a first duration and a second road feature characteristic may include a second duration. The second trained statistical model may be configured to classify a vehicle motion profile between the first duration and the second duration. Of course, any suitable road feature characteristic maybe employed to define any suitable number of classes for the trained statistical model. According to such embodiments, the second trained statistical model may further classify identified road features beyond mere detection of presence. Such classification may enable more effective proactive vehicle control, as the identified road feature characteristic may relate to an expected vehicle response to the road feature. Accordingly, a vehicle may be controlled based on the identified road feature characteristic.

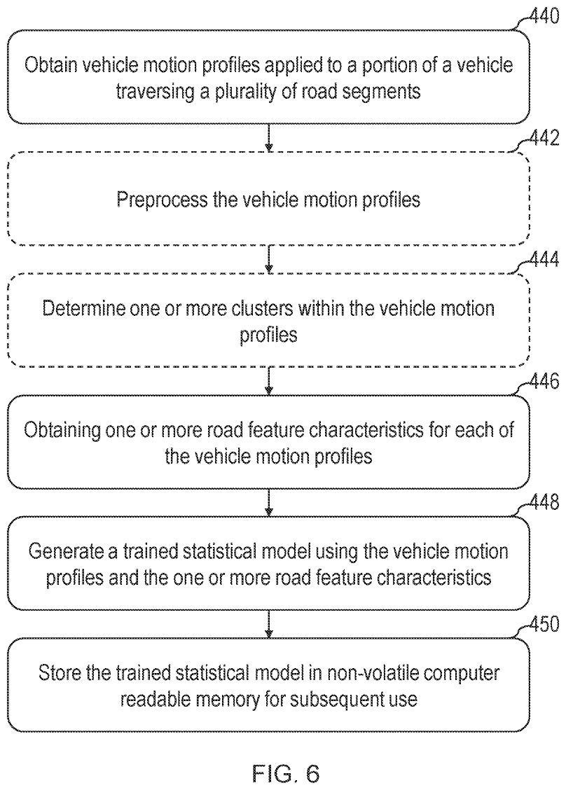

FIG. 6 illustrates a flow chart of another exemplary method of training a statistical model that can be used to classify motion profiles. In block 440, vehicle motion profiles applied to a portion of a vehicle traversing a plurality of road segments are obtained. The vehicle motion profiles may be associated with one or more unknown road feature characteristics. In block 442, optional preprocessing of the vehicle motion profiles may be performed. This may include filtering, windowing, or other suitable preprocessing techniques as described herein. In optional block 444, one or more clusters may be determined within the vehicle motion profiles. In some embodiments, clustering the vehicle motion profiles may include grouping the first vehicle motion profiles into a plurality of separate clusters of similar data points using a clustering algorithm. Each of the clusters may correspond to a different road feature characteristic. In block 446, one or more road feature characteristics may be obtained for each of the vehicle motion profiles. In some embodiments, the one or more road feature characteristics may be obtained from the clustering performed in block 444. In other embodiments, the one or more road feature characteristics may be obtained from a user (e.g., via user input). In block 448, a trained statistical model is generated using the vehicle motion profile and the one or more obtained road feature characteristics. In block 450, the trained statistical model is stored in non-volatile computer readable memory for subsequent use.

According to exemplary embodiments described herein, the inventors have recognized that different vehicles may respond to traversal of road features in different ways. For example, traversal of a road feature by a vehicle may induce resonant vibrations in the wheel that are known as “wheel hop.” The frequency of these vibrations, referred to as a wheel hop frequency, may depend on-vehicle specific parameters (for example, the frequency at which wheel hop occurs may be heavily influenced by a mass of the wheel, wheel damping, and/or a spring constant of the wheel). Thus, as discussed above, two motion profiles corresponding to traversal of the same road feature but collected in two different vehicles may have different parameters. As a result, a statistical model trained using datasets obtained from a first vehicle may fail when applied to datasets obtained from a second vehicle. In some embodiments, this may be overcome by using a statistical model that is specifically trained for each vehicle. That is, a first statistical model may be trained for a first vehicle and a second statistical model may be trained for a second vehicle.

In some cases, training a statistical model specific for a vehicle type may use substantial time, processing power, and memory, and the inventors have recognized it may be preferable if a single or a limited number of statistical model(s) were developed for a plurality of individual vehicle types. Accordingly, in some embodiments as described previously, a method may include attenuating a presence of vehicle-specific data from obtained vehicle motion profiles. Thus, in some embodiments, motion profiles may be, for example, filtered to remove or attenuate one or more vehicle specific responses. The filtered motion profile may then be used for training of the statistical model and/or for application of (e.g., classification by) the statistical model. For example, in some embodiments, a filter may be applied to attenuate presence of wheel-hop data in an obtained vehicle motion profile. In some embodiments, a presence of wheel-hop data may be attenuated by applying a band-pass filter having a stop-band frequency that includes a frequency of the wheel-hop. For example, presence of wheel-hop in an obtained vehicle motion profile may be attenuated by, for example, applying a notch filter having a stop-band frequency range that includes the wheel hop frequency of a given vehicle; by applying a low-pass filter having a cutoff frequency that is less than the frequency of wheel-hop; and/or by applying a high-pass filter having a cutoff frequency that is above the frequency of wheel-hop. The filtered motion profile may then be further processed (e.g., further transformed, filtered, normalized, integrated, differentiated, compressed, etc.) or segmented into appropriate windows.

In some embodiments, an obtained vehicle motion profile may undergo additional preprocessing steps prior to use (e.g., prior to being used for training the statistical model, and/or for analysis by the statistical model). For example, a motion profile may be transformed by application a Fourier transform (e.g., a fast Fourier transform) to transform the data to a frequency domain. In some embodiments, the motion profile may be transformed from a time domain to a spatial domain (e.g., by using knowledge of an operating speed of a vehicle). In some embodiments, processing of the motion profile may include differentiating the motion profile one or more times (e.g., acquired acceleration data may be integrated to yield velocity data). In some embodiments, the motion profile may be obtained by combining motion data corresponding to different portions of a vehicle—for example, a motion profile may represent vertical movement of a wheel of the vehicle relative to movement of a portion of a body of the vehicle (e.g., a motion profile may represent acceleration of the wheel relative to acceleration of the portion of the body off the vehicle). In addition, a motion profile may include a lateral or longitudinal motion of a portion of a body of the vehicle (e.g., longitudinal acceleration of a body of the vehicle). The processed motion profile may then be used to train the statistical model, and/or the processed motion profile may be analyzed (e.g., by the statistical model) to determine the presence of a given type of road feature.

In some embodiments, a motion profile originating in a first vehicle may, after appropriate preprocessing, be analyzed by (e.g., classified by) a statistical model that was trained using datasets (e.g., reference motion profiles) that originated in a second, different vehicle. In some embodiments, a single statistical model may be applicable to a class of individual vehicles. For example, a given statistical model may be appropriate for a particular model of a particular model year. In some embodiments, a system may include a plurality of statistical models, where each statistical model is associated with a different class of vehicles. For example, a system may include one statistical model applicable to subcompact cars, and a different statistical model applicable to compact cars. In these embodiments, information about an identity of a particular vehicle may be collected (e.g., a vehicle identification number, and/or a make/model), and an appropriate statistical model may be identified (e.g., by a computer processor) from the plurality of statistical models. The appropriate statistical model may then be used to analyze a motion profile collected from the particular vehicle type. In some embodiments, a system may include a plurality of statistical models, where each statistical model is associated with a certain type of vehicle regardless their make or model. For example, a system may include statistical models that are applicable specifically for sport vehicles, sedan vehicles, or SUVs, etc.

FIG. 7 is a flow chart for one embodiment of a method of determining a road feature characteristic associated with a vehicle motion profile. In block 460, a vehicle motion profile applied to a portion of a vehicle traversing a road segment is obtained. In optional block 462, a vehicle location associated with the vehicle location is obtained (e.g., via a GNSS or other localization system). In optional block 464, a vehicle motion profile may be filtered to produce a filtered vehicle motion profile (e.g., with a bandpass, notch, low-pass, and/or high pass filter). In block 466, a type of a road feature associated with the road segment is determined. For example, the method of FIG. 4 may be performed to classify the type of the road feature using a trained statistical model. In block 468, a trained statistical model may be selected to determine a characteristic of the road feature. The selected trained statistical model may be configured to classify a road feature within a particular road feature characteristic. For example, a trained statistical model may be configured to classify a road feature in terms of suspension response such as classifying between compression or extension. Of course, a trained statistical model may be configured to determine any desired road feature characteristic, as the present disclosure is not so limited. In block 470, the vertical motion profile is input to the trained statistical model, where the trained statistical model is configured to determine one or more road feature characteristics associated with the road segment based at least in part on the vehicle motion profile as discussed above. In block 472, the one or more road feature characteristics are output from the trained statistical model.

As discussed previously, the road feature characteristic may relate to the vehicle response when encountering a road feature. The road feature characteristic may represent a particular class of road feature which, in some embodiments, may inform vehicle control. For example, the one or more road feature characteristics may include one of a short duration (e.g., 0-0.5 seconds), medium duration (e.g., 0.5-2 seconds), and long duration (e.g., greater than 2 seconds). As another example, the one or more road feature characteristics may include a type of suspension response such as compression or extension. The identified one or more road characteristics may be associated with a geographical location and may be provided to a subsequent vehicle expected to encounter the road feature. The subsequent vehicle may employ the road feature characteristics to proactively control the vehicle, as shown in block 474.

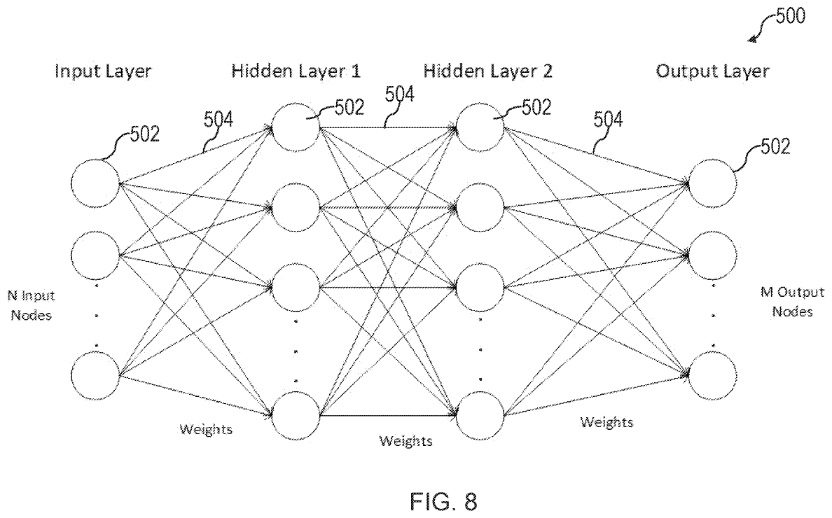

FIG. 8 illustrates a layer structure of an exemplary multi-class neural network 500 that may be used as a trained statistical model, in some embodiments. Each circle 502 in FIG. 8 represents a node also called a neuron, whereas each line 504 represents a connection between two nodes known as weight. The input layer consists of N nodes that may correspond to N machine learning features as described herein. The output layer consists of M nodes that may correspond to M number of classes (e.g., road feature types). As shown in FIG. 8, the network includes hidden layers that may include more than N number of nodes based on the desired complexity and each hidden layer may consist of different number of nodes. A neural network may have one, two, or more hidden layers. During the training process of a neural network, the connections (e.g., mathematical weights) between the input nodes, the hidden nodes, and the output nodes are calculated for each data point in to order to minimize a classification error. A trained neural network with known weights for all the possible connections among the nodes may then be applied to a new dataset with new input nodes to predict the value of the output nodes, for example, predicting a type of the road feature. If the input nodes of the trained neural network include data points from vehicle motion profiles that do not contain any road feature (e.g., are associated with an absence of a road feature), the neural network of FIG. 8 may be also used to identify road features among new motion profiles. In some embodiments, if vehicle motion profiles are associated with a geographical location, a map of identified road features may be generated and stored in a non-volatile computer memory.

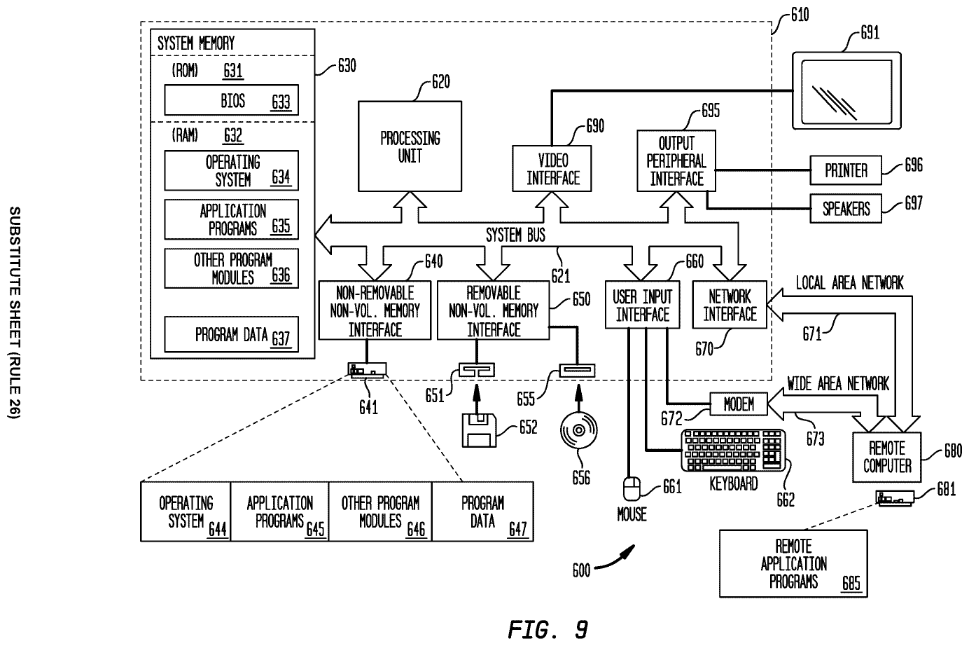

With reference to FIG. 9, an exemplary system for implementing aspects of the disclosure includes a general-purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random-access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 9 illustrates operating system 634, application programs 635, other program modules 636, and program data 637.

The computer 610 may also include other removable/non-removable, volatile/nonvolatile computer storage media. By way of example only, FIG. 9 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 9, provide storage of computer readable instructions, data structures, program modules and other data for the computer 610. In FIG. 9, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 9. The logical connections depicted in FIG. 9 include a local area network (LAN) 671 and a wide area network (WAN) 673 but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 9 illustrates remote application programs 685 as residing on memory device 681. It will be appreciated that the network connections shown are exemplary and other means of establishing a communications link between the computers may be used.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method comprising:
obtaining a vehicle motion profile applied to a portion of one or more vehicles traversing a road segment;
inputting, to a trained statistical model, the vehicle motion profile, wherein the trained statistical model is configured to identify one or more road features associated with the road segment based at least in part on the vehicle motion profile; and
outputting, from the trained statistical model, the one or more road features.

2. The method of claim 1, further comprising:
associating the one or more road features with one or more geographical locations; and
storing, in non-volatile computer readable memory, the one or more geographical locations of the one or more road features.

3. The method of claim 2, further comprising generating a map based on the one or more geographical locations.

4. The method of claim 1, further comprising filtering the vehicle motion profile to attenuate one or more vehicle-specific characteristics prior to inputting the vehicle motion profile to the trained statistical model.

5. The method of claim 4, wherein filtering the vehicle motion profile comprises filtering a first frequency of the vehicle motion profile to reduce artifacts of wheel-hop from the vehicle motion profile.

6. The method of claim 5, wherein filtering the vehicle motion profile comprises applying a notch filter to the vehicle motion profile, wherein a stop-band frequency range of the notch filter includes a frequency of the wheel-hop.

7. The method of claim 5, wherein filtering the vehicle motion profile comprises: applying a low-pass filter to the vehicle motion profile, wherein a cutoff frequency of the low-pass filter is less than a frequency of the wheel-hop.

8. The method of claim 5, wherein filtering the vehicle motion profile comprises applying a high-pass filter to the vehicle motion profile, wherein a cutoff frequency of the high-pass filter is above a frequency of the wheel-hop.

9. The method of claim 6, wherein the frequency of wheel-hop is between 10 and 15 Hz.

10. The method of claim 1, wherein obtaining the vehicle motion profile comprises traversing the road segment with the one or more vehicles while measuring vertical motion of the portion of the one or more vehicles using one or more motion sensors disposed in the one or more vehicle.

11. The method of claim 10, wherein the portion of the one or more vehicles includes a wheel of the one or more vehicles.

12. The method of claim 10, wherein the vehicle motion profile is measured as a function of time.

13. The method of claim 12, further comprising transforming the vehicle motion profile from a time domain to a distance domain prior to inputting the vehicle motion profile to the trained statistical model.

14. The method of claim 1, wherein the trained statistical model is a first trained statistical model, and further comprising:
inputting, to a second trained statistical model, the vehicle motion profile, wherein the second trained statistical model is configured to identify one or more road feature characteristics based at least in part on the vehicle motion profile; and
outputting, from the second trained statistical model, the one or more road feature characteristics.

15. The method of claim 14, wherein the one or more road feature characteristics include a road feature type.

16. The method of claim 15, wherein the road feature type includes one selected from a group of a speed bump, a pothole, a manhole cover, a storm grate, a frost heave, and an expansion joint.

17. The method of claim 15, wherein the one or more road feature characteristics include a size of the road feature.

18. The method of claim 1, wherein the vehicle motion profile is a first vehicle motion profile, wherein the one or more road features are one or more first road features, wherein the method further comprises:
obtaining a second vehicle motion profile applied to a portion of one or more vehicles traversing a second road segment;
inputting, to the trained statistical model, the second vehicle motion profile; and
outputting, from the trained statistical model, one or more second road features.

19. The method of claim 18, further comprising:
associating the one or more second road features with one or more second geographical locations; and
storing, in non-volatile computer readable memory, the one or more second geographical locations.

20. The method of claim 1, wherein the one or more road features correspond to one or more clusters identified in a training data set.

21. A method comprising:
obtaining first vehicle motion profiles applied to a portion of one or more vehicles traversing a first road segment associated with one or more road features;
obtaining second vehicle motion profiles applied to a portion of one or more vehicles traversing a second road segment associated with an absence of the one or more road features;
generating a trained statistical model using the first vehicle motion profiles and the second vehicle motion profiles; and
storing, in non-volatile computer readable memory, the trained statistical model.

22. The method of claim 21, wherein the trained statistical model is a first trained statistical model, wherein the method further comprises:
obtaining third vehicle motion profiles applied to a portion of the one or more vehicles traversing a first type of road feature;
obtaining road feature characteristic data associated with the third vehicle motion profiles;
generating a second trained statistical model using the third vehicle motion profiles and the road feature characteristic data; and
storing, in the non-volatile computer readable memory, the second trained statistical model.

23. The method of claim 22, wherein the first type of road feature includes one selected from a group of a speed bump, a pothole, a manhole cover, a storm grate, a frost heave, and an expansion joint.

24. The method of claim 21, further comprising transforming the first vehicle motion profiles and the second vehicle motion profiles into a frequency domain prior to generating the trained statistical model.

25. The method of claim 21, further comprising transforming the first vehicle motion profiles and the second vehicle motion profiles from a time domain into a distance domain prior to generating the trained statistical model.

26. The method of claim 21, wherein obtaining the first vehicle motion profiles comprises:
traversing, in the one or more vehicles, a first plurality of road segments, wherein each road segment of the first plurality of road segments includes the one or more road features; and
while traversing each road segment of the first plurality of road segments, measuring vehicle motion of the portion of the one or more vehicles.

27. The method of claim 21, wherein obtaining the second vehicle motion profiles comprises:
traversing, in the one or more vehicles, a second plurality of road segments, wherein each road segment of the second plurality of road segments does not include the one or more road features; and
while traversing each road segment of the second plurality of road segments, measuring vehicle motion of the portion of the one or more vehicles.

28. The method of claim 26, wherein the measured vehicle motion includes vertical motion of the portion of the one or more vehicles.

29. The method of claim 26, wherein the measured vehicle motion includes longitudinal motion of the one or more vehicles.

30. The method of claim 27, wherein the portion of the one or more vehicles includes a wheel.

31. The method of claim 21, further comprising identifying one or more clusters within the first vehicle motion profiles, wherein the trained statistical model is generated using the one or more clusters.

32. At least one non-transitory computer-readable storage medium storing programming instructions that, when executed by at least one processor, causes the at least one processor to perform the method of claim 1.
